(19) United States
(12) Patent Application Publication
(10) Pub. No.: US 2012/0121499 A1
(43) Pub. Date: May 17, 2012

(54) Transition Metal-Carbon Nanotube Hybrid Catalyst Containing Nitrogen, Method for Preparation Thereof, and Method for Generation of Hydrogen Using the Same

(75) Inventors: Jeung Ku KANG, Daejeon (KR); Seong Ho YANG, Daejeon (KR); Weon Ho SHIN, Daejeon (KR); Jun Hyeon BAE, Daejeon (KR)

(73) Assignee: Korea Advanced Instiute of Science and Technology, Daejeon (KR)

(21) Appl. No.: 13/350,553

(22) Filed: Jan. 13, 2012

Related U.S. Application Data
(62) Division of application No. 12/328,801, filed on Dec. 5, 2008.

(30) Foreign Application Priority Data
Dec. 13, 2007 (KR) 10-2007-0130117

(51) Int. Cl. C01B 3/04; B82Y 30/00

(52) U.S. Cl. 423/648.1; 977/902

(57) ABSTRACT

Disclosed are transition metal-carbon nanotube hybrid catalysts in which a transition metal having high catalytic activity is uniformly distributed on surface of a carbon nanotube containing nitrogen so as to maximize a surface area of the catalyst exhibiting catalytic activity, a method for preparation thereof, and a method for generation of hydrogen from an alkaline medium using the prepared catalyst. The transition metal-carbon nanotube hybrid catalyst containing N₂ according to the present invention is effectively used in a variety of industrial applications utilizing hydrogen energy such as a hydrogen storage systems for fuel cells, fuel storage systems for hydrogen fuel vehicles, electric vehicles and/or as energy sources for electronic devices.

### CROSS REFERENCE TO RELATED APPLICATIONS

This application claims priority to Korean Patent Application No. 10-2007-0130117, filed on Dec. 13, 2007, in the Korean Intellectual Property Office, which is incorporated herein by reference in its entirety.

### BACKGROUND OF THE INVENTION

1. Field of the Invention

The present invention relates to transition metal-carbon nanotube hybrid catalysts containing nitrogen, preparation thereof and a method for generation of hydrogen using the same. More particularly, the present invention relates to a transition metal-carbon nanotube hybrid catalyst containing nitrogen, in which transition metal powder having high catalytic activity was uniformly distributed in an interval of several nanometers on surface of a carbon nanotube so as to maximize surface area of the catalyst exhibiting catalytic activity. The present invention also relates to a method for preparation of the transition metal-carbon nanotube hybrid catalysts containing nitrogen and a method for generation of hydrogen from alkaline sodium tetrahydridoborate (alkaline NaBH₄) using the prepared catalyst.

2. Background

In general, a carbon nanotube is known as a nanostructural material having excellent thermal, mechanical and/or electrical properties and is drawing much attention as a material useful for various applications. In case that a transition metal is adhered to a carbon nanotube, the carbon nanotube can exhibit improved material properties and be useable as a hybrid material expressing new characteristics.

At present, conventional catalysts for generating hydrogen in alkaline NaBH₄ solution comprise noble metal such as Pt, Ru, etc.

Due to complicated processes for preparation and difficulty in mass production, such known catalysts show limitations in economical and/or time consumption aspects in view of practical applications thereof.

Other than noble metal based catalysts, examples of a catalytic material possible to generate hydrogen in alkaline NaBH₄ solution are Co and Ni.

Co and Ni are stable elements in a strong base solution and have considerable economical advantage compared to Pt, Ru and other metals.

However, such a catalyst typically exists in a powder state and has a limited surface area, thus encountering a problem of decreased activity thereof.

### BRIEF SUMMARY OF THE INVENTION

Accordingly, the present invention has been proposed to solve problems of conventional techniques described above, and an object of the present invention is to provide a transition metal-carbon nanotube hybrid catalyst with improved performance obtained by dispersing a transition metal in carbon nanotube containing nitrogen (N₂).

Another object of the present invention is to provide a method for preparation of transition metal-carbon nanotube hybrid catalyst containing N₂ using a transition metal having high catalytic activity as well as highly reactive nitrogen as a medium, wherein nanoparticles with well controlled size are uniformly distributed in the catalyst.

A still further object of the present invention is to provide a high efficiency of hydrogen generation method using the transition metal-carbon nanotube hybrid catalyst containing N₂ described above.

In order to accomplish the above described objects, the present invention provides a transition metal-carbon nanotube hybrid catalyst containing nitrogen, comprising a carbon nanotube in which transition metal nanoparticles with a uniform size are distributed.

The present invention also provides a method for preparation of a transition metal-carbon nanotube hybrid catalyst, comprising: dispersing a carbon nanotube containing N₂ in a reductive solvent containing a transition metal salt; and reducing the transition metal salt. Additionally, the present invention provides a method for preparation of a transition metal-carbon nanotube hybrid catalyst containing nitrogen, comprising: dispersing a carbon nanotube containing N₂ in a reductive solvent and adding a transition metal salt thereto; and reducing the transition metal salt.

Furthermore, the present invention provides a method for preparation of hydrogen using the transition metal-carbon nanotube hybrid catalyst containing N₂ prepared according to the present invention as a catalyst.

Using the transition metal-carbon nanotube hybrid catalyst containing N₂ prepared by the present invention can generate hydrogen with high capacity from alkaline NaBH₄ solution under necessary temperature conditions. Therefore, the present invention has beneficial effects of more simplifying a method for hydrogen storage compared to conventional methods such as method for compressed gas storage, liquefied gas storage, hydrogen storage using hydrogen storage alloys and so on, reducing the size of a hydrogen storage tank and/or investment costs because of high storage capacity of hydrogen.

### BRIEF DESCRIPTION OF THE DRAWINGS

These and other objects, features, aspects, and advantages of the present invention will be more fully described in the following detailed description of an embodiment of the present invention, taken in conjunction with the accompanying drawings. In the drawings:

FIG. 1A is a transmission electron microscope (TEM) picture showing a Co-carbon nanotube hybrid catalyst comprising Co nanoparticles with a highly uniform distribution and a uniform size prepared using a carbon nanotube containing N₂;

FIG. 1B is a picture showing a carbon nanotube distinguished from Co particles observed by a High Angle Annular Dark Field Detector;

FIG. 2A is graphs illustrating hydrogen generation rate of a Co-carbon nanotube hybrid catalyst comprising Co nanoparticles with a highly uniform distribution and a uniform size prepared using a carbon nanotube containing N₂, compared to those of a Pt/C powder catalyst, a Co powder catalyst and a Ni powder catalyst.

FIG. 2B is graphs illustrating hydrogen generation amount (mL) per time (sec) of a Co-carbon nanotube hybrid catalyst comprising Co nanoparticles with a highly uniform distribution and a uniform size prepared using a carbon nanotube containing N₂, compared to those of a Pt/C powder catalyst, a Co powder catalyst and a Ni powder catalyst;

FIG. 3A is a TEM picture showing Pt/C powder containing 50 wt. % Pt;

FIG. 3B is a high resolution transmission electron microscope (“HRTEM”) picture showing Pt/C powder containing 50 wt. % Pt;

FIG. 4A is a low resolution scanning electron microscope (“SEM”) picture showing Co bulk powder;

FIG. 4B is a high-resolution scanning electron microscope (“HRSEM”) picture showing Co bulk powder;

FIG. 4C is a low-resolution SEM picture showing Ni bulk powder; and

FIG. 4D is a HRSEM picture showing Ni bulk powder.

One or more embodiments of the present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described can include a particular feature, structure, or characteristic, but every embodiment will not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

References to spatial descriptions (e.g., “above”, “below”, “up”, “down”, “top”, “bottom,” etc.) made herein are for purposes of description and illustration only, and should be interpreted as non-limiting upon the nanotube hybrid catalysts, methods, and products of any method of the present invention, which can be spatially arranged in any orientation or manner.

In a first aspect of the present invention, there is provided a transition metal-carbon nanotube hybrid catalyst comprising a carbon nanotube containing nitrogen (N₂) in which transition metal nanoparticles with a uniform size are distributed.

Such a transition metal-carbon nanotube hybrid catalyst of the present invention can contain nitrogen (N₂) in an amount of about 0.01 atomic-% to about 20 atomic-%, or about 1 atomic-% to about 15 atomic-%.

Since transition metal-carbon nanotube hybrid catalyst of the present invention contains nitrogen causing structural defects on surface of the carbon nanotube, there can be an increase in thermodynamic energy and formation of bonds between the transition metal nanoparticles and carbon atoms at defect portions, resulting in a uniform distribution of the transition metal nanoparticles on a surface of the carbon nanotube or possibly distribution thereof over the entire structure of the carbon nanotube.

The transition metal contained in the hybrid catalyst of the present invention is not particularly limited if it can be combined with the carbon nanotube, and in some embodiments comprises at least one transition metal selected from: iron (Fe), cobalt (Co), nickel (Ni) and/or metallic compounds thereof. Not being bound by any particular theory, because these transition metals have relatively higher catalytic activity and bonding energy between the transition metal and a carbon nanotube compared to other transition metals, stable hybrid carbon nanotubes are formed.

The hybrid catalyst of the present invention is useful in various applications, for example, as a reactive catalyst to enhance H₂ generation rate during H₂ generation.

The transition metal-carbon nanotube hybrid catalyst of the present invention is applied to a catalytic material having high H₂ generation rate in an alkaline NaBH₄ solution contained in a fuel cell. BH₄⁻ ions of the alkaline NaBH₄ solution serve as a carrier for delivering electrons to the carbon nanotube while generating H₂.

In a second aspect of the present invention, there is provided a method for preparation of a transition metal-carbon nanotube hybrid catalyst containing nitrogen, comprising: dispersing a carbon nanotube containing N₂ in a reductive solvent containing a transition metal salt; and reducing the transition metal salt.

In a third aspect of the present invention, there is provided a method for preparation of a transition metal-carbon nanotube hybrid catalyst containing nitrogen, comprising: dispersing a carbon nanotube containing N₂ in a reductive solvent and adding a transition metal salt thereto; and reducing the transition metal salt.

As to the method for preparation of a transition metal-carbon nanotube hybrid catalyst according to an embodiment of the present invention, the transition metal contained in the hybrid catalyst of the present invention is not particularly limited if it can be combined with the carbon nanotube. In some embodiments, the transition metal comprises at least one metal selected from: iron (Fe), cobalt (Co), nickel (Ni) and/or metallic compounds thereof. Considering these transition metals have relatively higher catalytic activity and form relative high-energy bonds with a carbon nanotube, stable transition metal-carbon nanotube hybrid strictures are thereby formed.

As to the inventive method for preparation of the transition metal-carbon nanotube hybrid catalyst, the transition metal salt is not particularly limited so long as it includes a transition metal. In some embodiments, a transition metal salt is selected from the group that includes: an acetate salt, a chloride salt, and combinations thereof. In some embodiments, a transition metal can be dissolved in a reductive solvent to prepare a uniform metal salt.

As to the inventive method for preparation of the transition metal-carbon nanotube hybrid catalyst, the reductive solvent in some embodiments is a polyol since the solvent conducts reduction of transition metal and derives bonding of the reduced metal to the carbon nanotube. More particularly, in some embodiments a reductive solvent is selected from: ethyleneglycol, diethyleneglycol, polyethyleneglycol, 1,2-propanediol, dodecanediol, and combinations thereof.

As to the inventive method for preparation of the transition metal-carbon nanotube hybrid catalyst, the carbon nanotube containing N₂ is prepared by reacting hydrocarbon gas with N₂ gas through plasma CVD in the presence of metal catalyst.

Such the metal catalyst is not particularly limited so long as it can perform a catalytic reaction when the carbon nanotube is formed, however, can comprise at least one selected from: Fe, Co, Ni and/or metallic compounds thereof with considering that these have relatively higher catalytic activity and bonding energy between the metal and the carbon nanotube rather than other transition metals, thus stably existing in the carbon nanotube. In some embodiments, the metallic compounds include, but are not limited to, iron acetate, cobalt acetate, nickel acetate and the like.

Hydrocarbon gas and N₂ gas used in the plasma CVD method are often supplied respectively to the metal catalyst and a ratio of the volume of hydrocarbon gas to N₂ gas supplied is about 1:99 to about 99:1 (v/v), about 10:90 to about 90:10 (v/v), or about 20:80 to about 80:20 (v/v).

The hydrocarbon gas used herein is not particularly limited but can comprise light hydrocarbons such as methane having one (1) carbon atom, acetylene having two (2) carbon atoms, and the like.

As to the inventive method for preparation of the transition metal-carbon nanotube hybrid catalyst, the plasma CVD method can use microwave, RF power and/or DC power as a plasma source without particular restriction thereof.

As to the inventive method for preparation of the transition metal-carbon nanotube hybrid catalyst, if the N₂ content of the carbon nanotube containing nitrogen is too small, the area of the carbon nanotube on which the metal salt is reduced will be decreased. On the other hand, excessive N₂ content in the carbon nanotube can cause the three-dimensional structure of the carbon nanotube to breakdown or become distorted. Therefore, the N₂ content of the carbon nanotube can range from about 0.01 atomic-% to 20 atomic-%, or about 1 atomic-% to about 15 atomic-%.

As to the inventive method for preparation of the hybrid catalyst, the step of reducing the transition metal salt can be performed by adding a reductive agent to the salt and heating the mixture. The reductive agent is not particularly limited, and can include sodium hydroxide (NaOH), metal hydrides such as sodium tetrahydridoborate (NaBH₄), lithium aluminum hydride (LiAlH₄), etc. and mixtures thereof. The heating process can be conducted in a microwave oven by any conventional method, for example, to perform the reduction step.

Depending on characteristics of the hybrid catalyst comprising metallic particles uniformly distributed in the carbon nanotube according to the present invention, an amount of the transition metal salt used can vary in view of uses thereof. Moreover, the inventive hybrid catalyst can include transition metal nanoparticles with a well controlled size by adjusting a concentration of the transition metal salt.

The inventive method for fabrication of the transition metal-carbon nanotube hybrid catalyst can further comprises centrifuging the dispersed solution, vacuum drying and heat treating the centrifuged solution after reducing the transition metal salt. The centrifugation, vacuum drying and heat treatment can be performed by any of conventional methods well known in the art.

In a fourth aspect of the present invention, there is provided a method for preparation of hydrogen using a transition metal-carbon nanotube hybrid catalyst containing N₂.

As an exemplary embodiment of the present invention, the method for generation of hydrogen comprises introducing the transition metal-carbon nanotube hybrid catalyst to an alkaline NaBH₄ solution to generate hydrogen. The alkaline NaBH₄ solution can be prepared by adding NaBH₄ to a strong base solution. In some embodiments, a base for use in a strong base solution is selected from: NaOH, LiOH, KOH, Ca(OH)₂, Ba(OH)₂, and combinations thereof.

NaBH₄ existing in an aqueous solution with a very high pH at room temperature and ambient pressure is stable in view of thermodynamics so that this compound can be stably stored in the air for several months and rapidly react with the catalyst introduced thereto to generate hydrogen.

An amount of H₂ generation can be measured by a gas flow meter and, since the H₂ generation depends on an amount of introducing the catalyst, a gas flow meter can be selected to effectively measure the amount of H₂ generation in a detectable range thereof.

Hereinafter, exemplary embodiments of the present invention will be described in detail with reference to the following examples, which are only given for the purpose of illustration and not to be construed as limiting the scope of the invention.

### Example 1

### Preparation of Co-Carbon Nanotube Hybrid Catalyst (1)

A catalyst for growing C₁₋ₓNₓ nanotube was prepared by a magnetron RF sputtering method, wherein x ranges in 0<x<1.

In this case, a SiO₂/Si substrate was used and cobalt (“Co”) was deposited at a deposition temperature of 200° C. and a pressure of 15 torr in Argon atmosphere. The deposition was performed at RF power of 100 W and a Co deposition thickness on the substrate was set to 7 nm.

In order to form catalyst particles from a Co layer deposited on the substrate, a plasma treatment was conducted for 1 minute using microwave enhanced CVD equipment with microwave power of 700 W.

When Co particles were formed on the substrate, the substrate having Co particles was placed in a chamber, followed by adding 15% methane (CH₄) and 85% N₂ thereto. Next, a plasma reaction was performed to prepare a carbon nanotube containing N₂. At this time, the chamber was maintained at a temperature of 750° C. and a pressure of 21 torr and the plasma reaction was conducted with a microwave power of 700 W for 20 minutes.

After adding 5 mg of the carbon nanotube containing N₂ to 50 mL ethyleneglycol solution, the mixture was dispersed using ultrasonic waves. 1 mL of 10 mM Co(CH₃COO)₂.4H₂O and 8 mg of NaOH as a reductive agent were added to the dispersed solution, followed by heating the mixture in a microwave oven for 90 seconds to reduce a metal salt. Then, the dispersed solution was sequentially subjected to centrifugation at 4,500 rpm for 15 minutes, vacuum drying at 60° C. and heat treatment at 300° C. in a hydrogen atmosphere to prepare a Co-carbon nanotube hybrid catalyst as a final product.

### Example 2

### Preparation of Co-Carbon Nanotube Hybrid Catalyst (2)

A Co-carbon nanotube hybrid catalyst was prepared by the same procedure as described in Example 1, except that, after adding 5 mg of a carbon nanotube containing N₂ to 50 mL ethyleneglycol solution to which 1 mL of 10 mM Co(CH₃COO)₂.4H₂O was added, the mixture was dispersed using ultrasonic waves.

### Example 3

### Preparation of Fe-Carbon Nanotube Hybrid Catalyst (3)

A Fe-carbon nanotube hybrid catalyst was prepared by the same procedure as described in Example 1, except that Fe(CH₃COO)₂.4H₂O was used as a transition metal salt instead of Co(CH₃COO)₂.4H₂O.

### Example 4

### Preparation of Ni-Carbon Nanotube Hybrid Catalyst

A Ni-carbon nanotube hybrid catalyst was prepared by the same procedure as described in Example 1, except that Ni(CH₃COO)₂.4H₂O was used as a transition metal salt instead of Co(CH₃COO)₂.4H₂O.

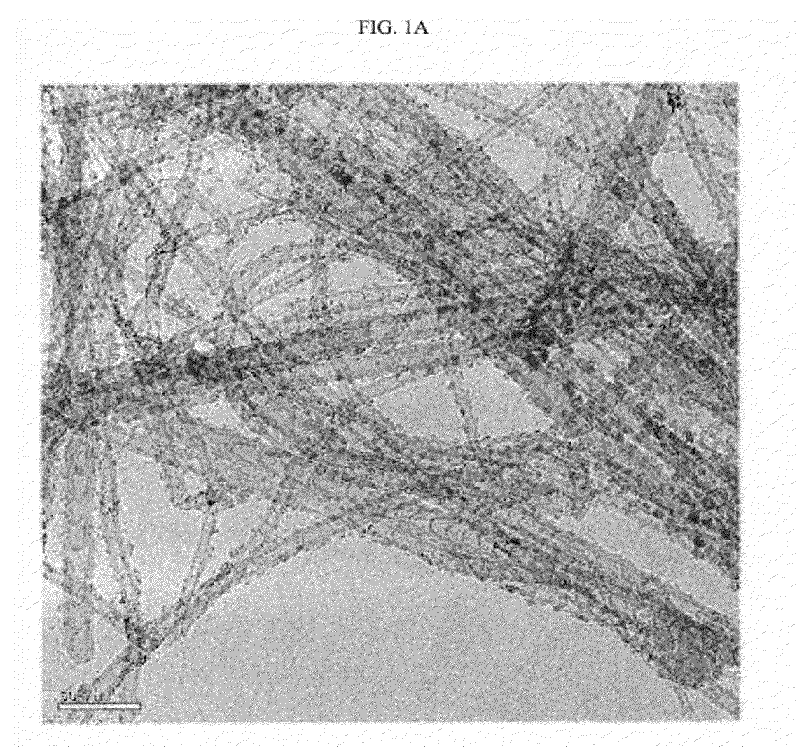

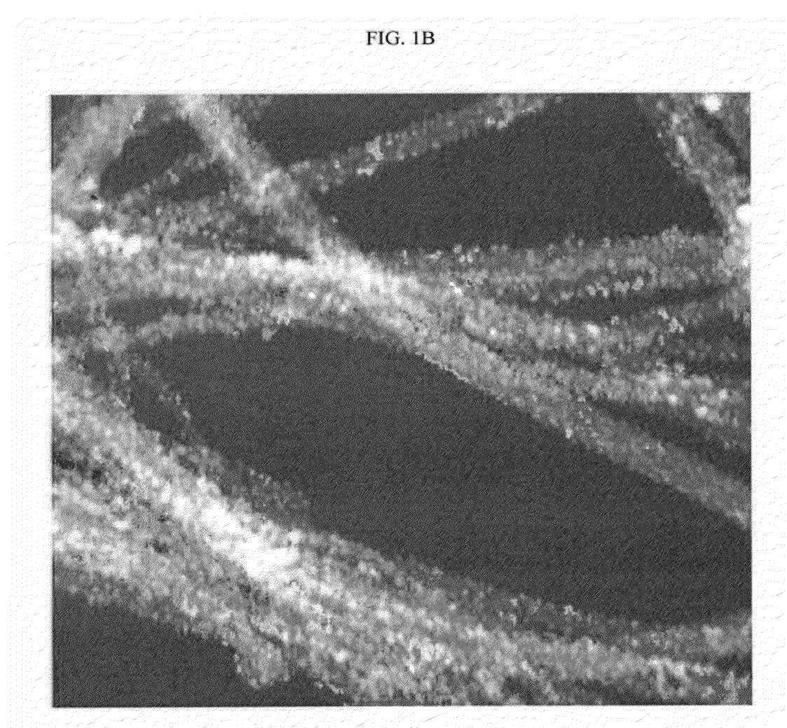

FIG. 1A is a TEM picture showing a Co-carbon nanotube hybrid catalyst prepared in Examples 1 and 2. Referring to FIG. 1A, it can be seen that Co metallic particles have a highly uniform distribution and a uniform size.

FIG. 1B is a high-angle annular dark-field (HAADF) picture showing Co metallic particles and the carbon nanotube of the Co-carbon nanotube hybrid catalyst. Referring to FIG. 1B, it can be seen that Co metallic particles are distributed on an outer wall of the carbon nanotube.

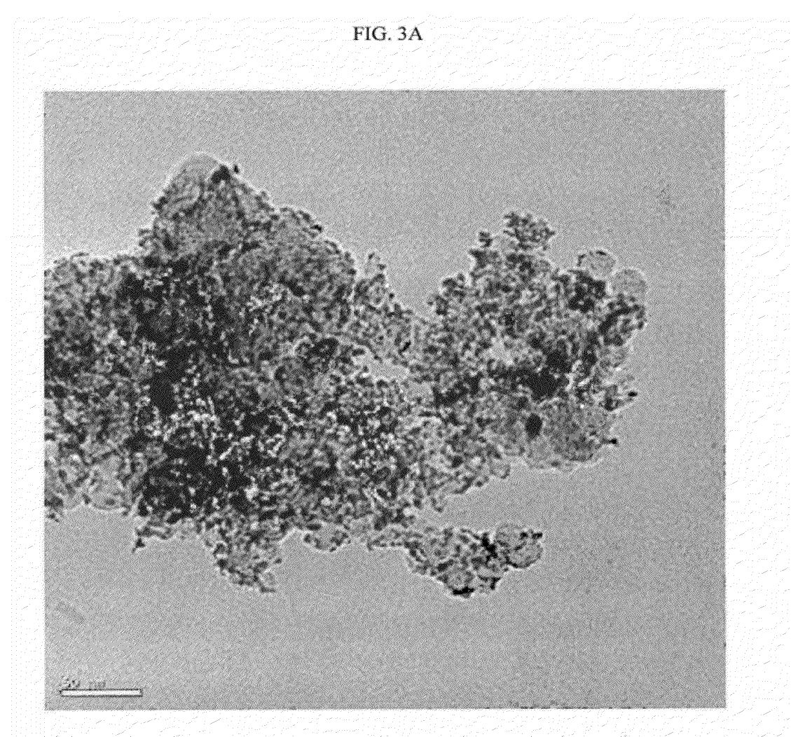

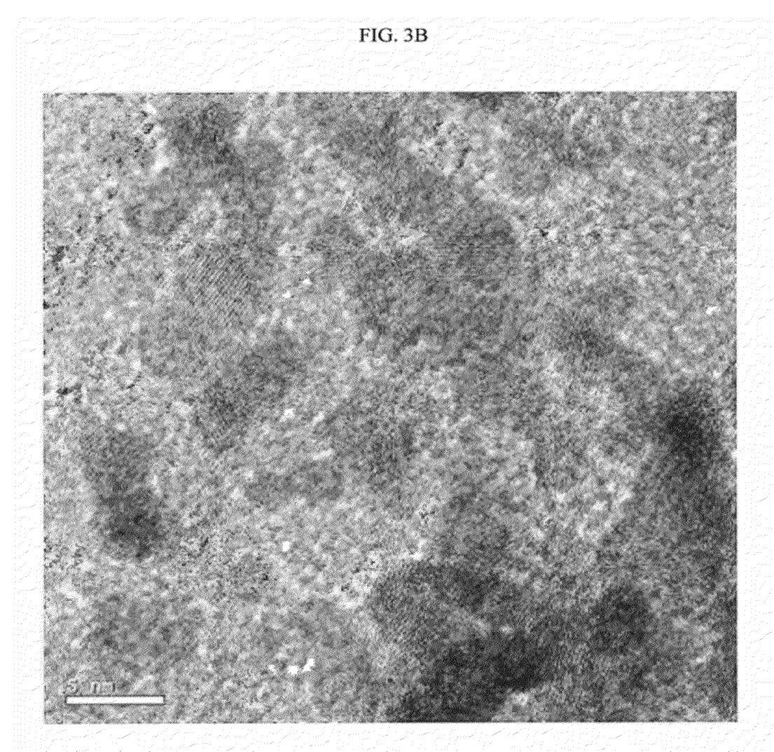

FIG. 3A is a TEM picture showing Pt/C powder containing 50 wt. % of Pt metallic particles; and FIG. 3B is a HRTEM picture showing Pt/C powder containing 50 wt. % of Pt metallic particles. Referring to FIG. 3B, it can be seen that Pt metallic particles are distributed in an interval of about 2 to 5 nm, which are different from Co metallic particles shown in FIG. 1B.

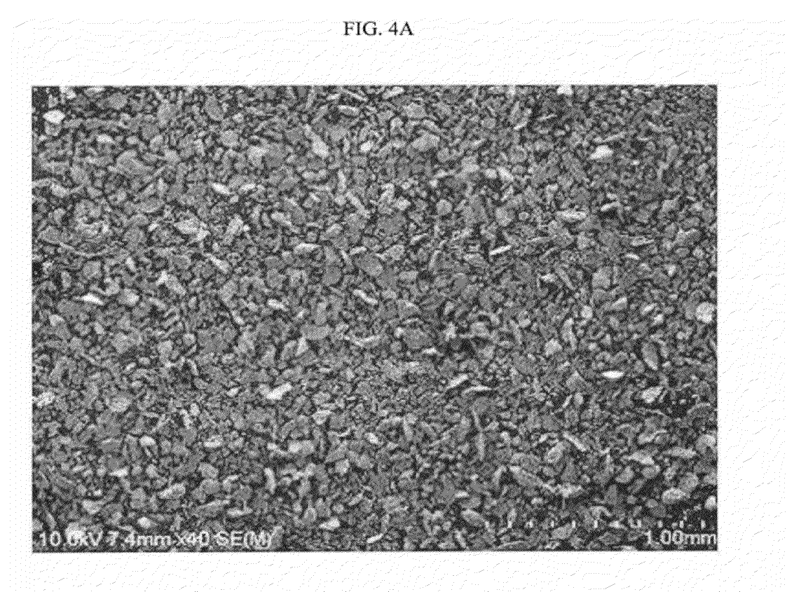

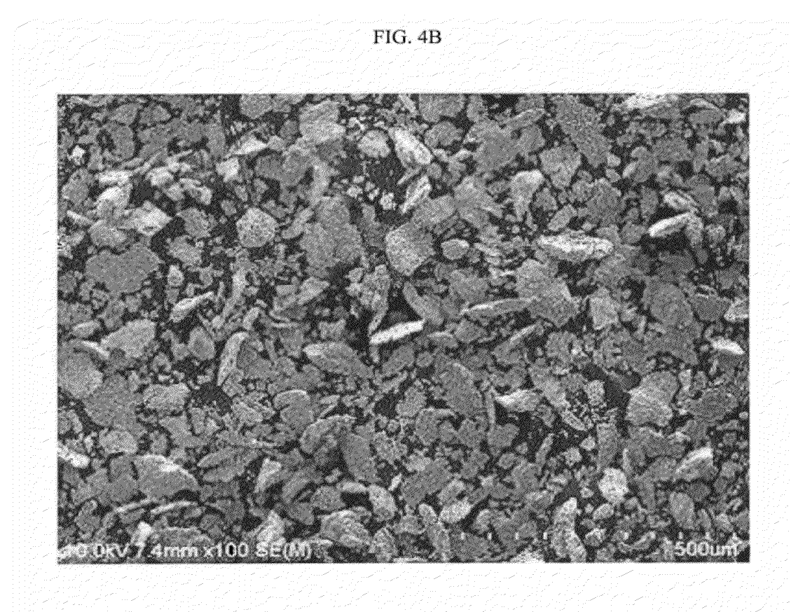

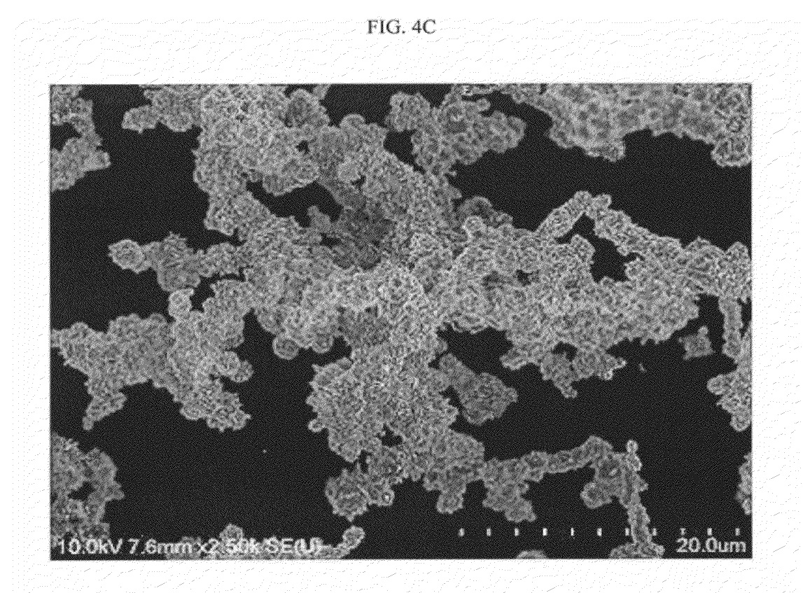

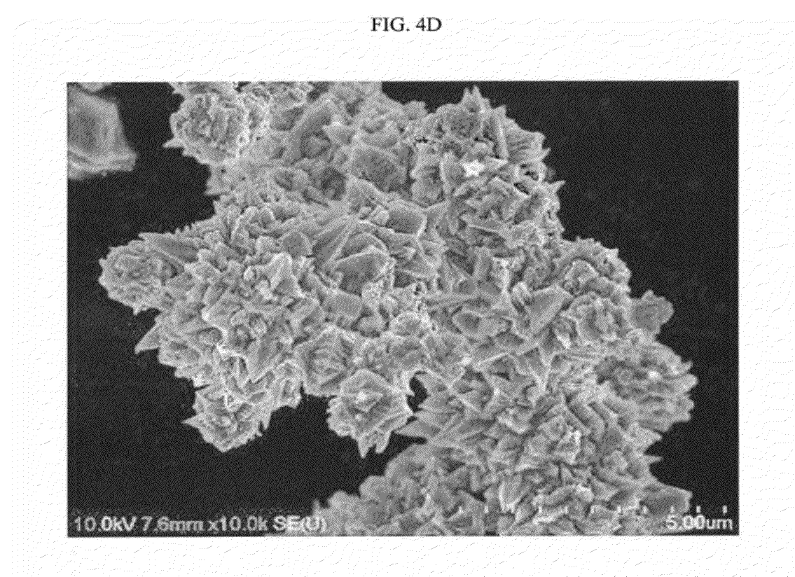

FIGS. 4A, 4B, 4C and 4D are SEM pictures showing Co bulk powder, a HRSEM picture showing Co bulk powder, a SEM picture showing Ni bulk powder and a HRSEM picture showing Ni bulk powder, respectively. Referring to FIGS. 4B and 4D, respectively, it can be seen that the size of particles is within a wider range of several to several hundreds of micrometers than that of Co particles shown in FIG. 1B.

### Example 5

### Measurement of H₂ Generated Using the Catalyst of the Present Invention

10 wt-% of NaOH was added to 50 mL distilled water to provide a strong base solution, which was followed by adding 15 wt-% of NaBH₄ to the strong base solution at room temperature to prepare an alkaline NaBH₄ solution.

The Co-carbon nanotube hybrid catalyst prepared by Examples 1 and 2 was introduced into the prepared alkaline NaBH₄ solution to generate H₂. An amount of H₂ generation was determined using a gas flow meter.

In this example, a Pt/C powder containing 50 wt-% of Pt metallic particles, a Co powder and a Ni powder were used as control group.

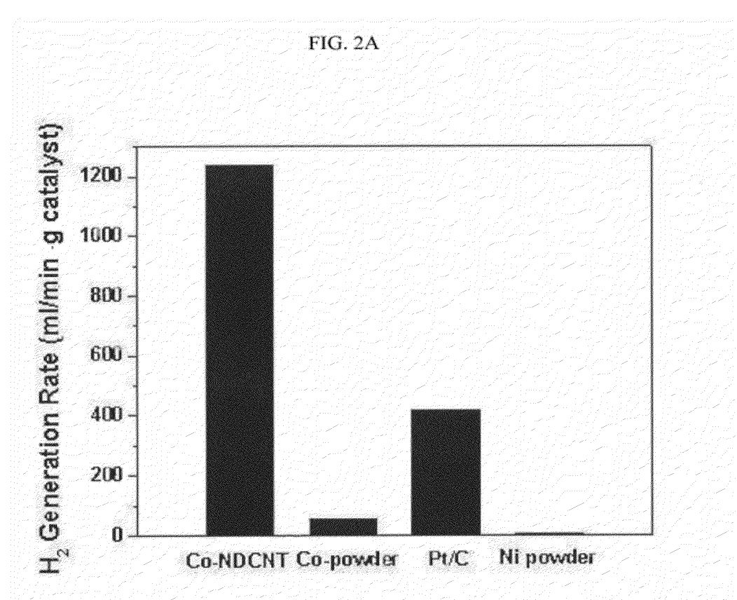

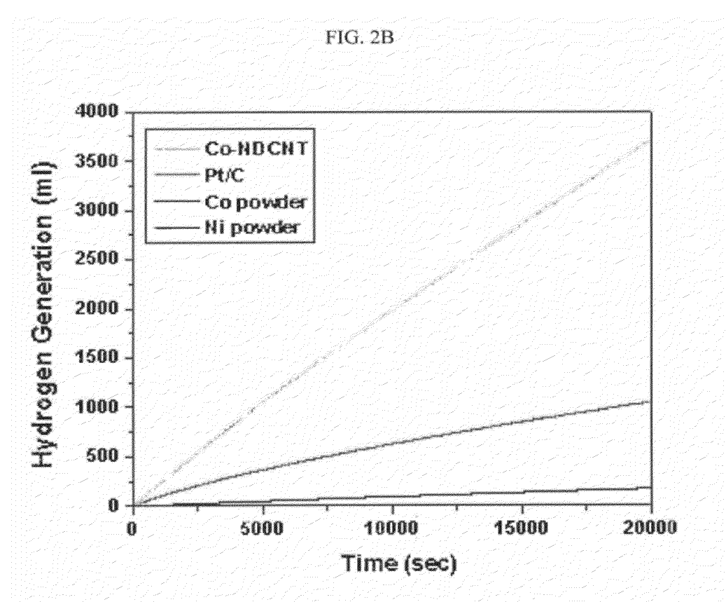

FIG. 2A provides graphs that illustrate the H₂ generation rate from a Co-carbon nanotube hybrid catalyst of the present invention containing Co nanoparticles having a highly uniform distribution and a uniform size. Referring to FIG. 2A, compared to the control group (which included a Pt/C powder catalyst, a Co powder catalyst, and a Ni powder catalyst), the transition metal-carbon nanotube of the present invention noticeably improved H₂ generation rate.

FIG. 2B provides graphs illustrating H₂ generation amount (mL) per time (sec) of a Co-carbon nanotube hybrid catalyst of the present invention, compared to the H₂ generated using a control group (i.e., a Pt/C powder catalyst, a Co powder catalyst and a Ni powder catalyst). Referring to FIG. 2B, it can be seen that using the transition metal-carbon nanotube of the present invention can noticeably improve H₂ generation amount compared to all of the control group.

The transition metal-carbon nanotube hybrid catalyst according to the present invention can be applied in a variety of industrial fields, especially, utilizing hydrogen energy such as a hydrogen storage system for fuel cells, a fuel storage system for hydrogen fuel vehicles, an electric vehicle and/or a driving source for small sized electronic devices.

Although the present invention has been described in detail reference to the best mode, it will be understood by those skilled in the art that various modifications and equivalents can be made without departing from the spirit and scope of the present invention, as set forth in the appended claims.

### CONCLUSION

These examples illustrate possible embodiments of the present invention. While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

1-16. (canceled)

17. A method for generation of hydrogen, comprising:
providing a transition metal-carbon nanotube hybrid catalyst comprising a nitrogen-containing carbon nanotube in which transition metal nanoparticles with a uniform size are distributed; and
introducing the transition metal-carbon nanotube hydride catalyst to an alkaline NaBH₄ solution to generate hydrogen.

18. (canceled)

19. The method according to claim 17, wherein the alkaline NaBH₄ solution is prepared by adding NaBH₄ to a strong base solution.

20. The method according to claim 19, wherein a base of the strong base solution comprises a base selected from: NaOH, LiOH, KOH, Ca(OH)₂ and Ba(OH)₂.

21. The method according to claim 17, wherein the catalyst contains about 0.01 atomic-% to about 20 atomic-% of N₂.

22. The method according to claim 17, wherein the transition metal nanoparticles are uniformly distributed on a surface of the carbon nanotube.

23. The method according to claim 17, wherein the transition metal is selected from iron (Fe), cobalt (Co), nickel (Ni) and metallic compounds thereof.
